(19) United States
(12) Patent Application Publication
(10) Pub. No.: US 2019/0065938 A1
(43) Pub. Date: Feb. 28, 2019

(54) Apparatus and Methods for Pooling Operations

(71) Applicant: Cambricon Technologies Corporation Limited, Beijing (CN)

(72) Inventors: Shaoli Liu, Beijing (CN); Jin Song, Beijing (CN); Yunji Chen, Beijing (CN); Tianshi Chen, Beijing (CN)

(21) Appl. No.: 16/174,064

(22) Filed: Oct. 29, 2018

Related U.S. Application Data
(63) Continuation-in-part of application No. PCT/CN2016/080696, filed on Apr. 29, 2016.

(51) Int. Cl. G06N 3/04

(52) U.S. Cl. CPC G06N 3/0454

(57) ABSTRACT

Aspects for pooling operations in a multilayer neural network (MNN) in a MNN acceleration processor are described herein. The aspects may include a direct memory access unit configured to receive multiple input values from a storage device. The aspects may further include a pooling processor configured to select a portion of the input values based on a pooling kernel that include a data range, and generate a pooling result based on the selected portion of the input values.

### CROSS-REFERENCE TO RELATED APPLICATIONS

The present invention is a continuation-in-part of PCT Application No. PCT/CN2016/080696, filed on Apr. 29, 2016, the entirety of which is incorporated herein by reference. The entirety of commonly owned CN Application No. 201610282148.8, filed on Apr. 29, 2016, is also incorporated herein by reference.

### BACKGROUND

Multilayer neural networks (MNN) are widely applied to the fields such as pattern recognition, image processing, functional approximation and optimal computation. In recent years, due to the higher recognition accuracy and better parallelizability, multilayer artificial neural networks have received increasing attention.

A known method to support the pooling operations of a multilayer artificial neural network is to use a general-purpose processor. Such a method uses a general-purpose register file and a general-purpose functional unit to execute general purpose instructions. However, one of the defects of the method is lower operational performance of a single general-purpose processor which cannot meet performance requirements for usual multilayer neural network operations. When multiple general-purpose processors execute concurrently, the intercommunication among them also becomes a performance bottleneck. In addition, a general-purpose processor needs to decode the reverse computation of a multilayer artificial neural network into a long queue of computations and access instruction sequences, and a front-end decoding on the processor brings about higher power consumption.

Another known method to support the pooling operations of the multilayer artificial neural network is to use a graphics processing unit (GPU). Such a method uses a general-purpose register file and a general-purpose stream processing unit to execute general purpose single-instruction-multiple-data (SIMD) instructions to support the algorithm. Since GPU is an apparatus specially for executing graph and image operation as well as scientific computation and fails to specially support multilayer artificial neural network operations, the GPU remains in need of a great amount of front-end decoding to execute multilayer artificial neural network operations, thus producing plenty of additional overheads. Besides, since GPU only contains rather small on-chip caching, then model data (e.g., pooling kernel) of a multilayer artificial neural network may be repeatedly moved from the off-chip, and off-chip bandwidth becomes a main performance bottleneck, causing huge power consumption.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One example aspect of the present disclosure provides an example apparatus for performing pooling operations in a neural network. The example apparatus may include a direct memory access unit configured to receive multiple input values from a storage device. In addition, the example apparatus may include a pooling processor configured to select a portion of the input values based on a pooling kernel that include a data range, and generate a pooling result based on the selected portion of the input values.

Another One example aspect of the present disclosure provides an example method for performing pooling operations in a neural network. The example method may include receiving, by a direct memory access unit, multiple input values from a storage device; selecting, by a pooling processor, a portion of the input values based on a pooling kernel that include a data range; and generating, by the pooling processor, a pooling result based on the selected portion of the input values.

To the accomplishment of the foregoing and related ends, the one or more aspects comprise the features herein after fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram illustrating an example computing process of forward propagation and backpropagation in an MNN;

FIG. 2 is a block diagram illustrating an example MNN acceleration processor by which pooling operations may be implemented in a neural network;

FIG. 3 is a block diagram illustrating an example pooling processor by which pooling operations may be implemented in a neural network; and

FIG. 4 is a flow diagram of aspects of an example method for pooling operations in a neural network.

### DETAILED DESCRIPTION

Various aspects are now described with reference to the drawings. In the following description, for purpose of explanation, numerous specific details are set forth in order to provide a thorough understanding of one or more aspects. It may be evident, however, that such aspect(s) may be practiced without these specific details.

In the present disclosure, the term “comprising” and “including” as well as their derivatives mean to contain rather than limit; the term “or”, which is also inclusive, means and/or.

In this specification, the following various embodiments used to illustrate principles of the present disclosure are only for illustrative purpose, and thus should not be understood as limiting the scope of the present disclosure by any means. The following description taken in conjunction with the accompanying drawings is to facilitate a thorough understanding to the illustrative embodiments of the present disclosure defined by the claims and its equivalent. There are specific details in the following description to facilitate understanding. However, these details are only for illustrative purpose. Therefore, persons skilled in the art should understand that various alternation and modification may be made to the embodiments illustrated in this description without going beyond the scope and spirit of the present disclosure. In addition, for clear and concise purpose, some known functionality and structure are not described. Besides, identical reference numbers refer to identical function and operation throughout the accompanying drawings.

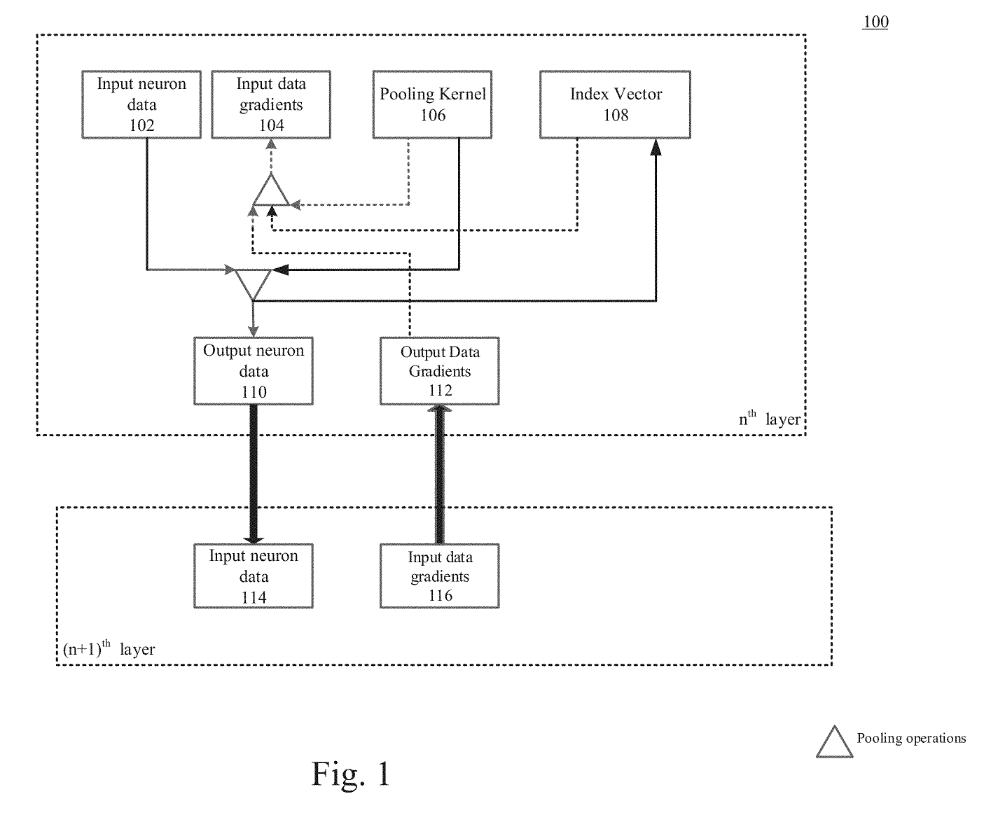

FIG. 1 is a block diagram illustrating an example computing process 100 of forward propagation and backpropagation in an MNN. The computing process 100 is merely an example showing neural network operations that involve input data (e.g., input neuron data 102) and a pooling kernel 106 and is not limited to such operations. For example, other unshown neural network operations may include convolution operations, etc.

As depicted, the example computing process 100 may be performed from the n^{th} layer to the (n+1)^{th} layer. The term “layer” here may refer to a group of operations, rather than a logic or a physical layer. A triangular-shaped operator (Δ as shown in FIG. 1) may indicate one or more pooling operations. Examples of the pooling operations in the neural network may include one or more maxpooling operations or one or more average pooling operations. It is notable that the illustrated layers of operations may not be the first layer and the last layer of the entire process. Rather, the layers of operations may refer to any two consecutive layers in a neural network. As described in greater detail, the computing process from the n^{th} layer to the (n+1)^{th} layer may be included as a part of a forward propagation process; the computing process from the (n+1)^{th} layer to the n^{th} layer may be included in a backpropagation process (interchangeably “a backward propagation process”).

The forward propagation process may include a partial process starting from input neuron data received at the n^{th} layer (e.g., input neuron data 102). Hereinafter, input neuron data may refer to the input data at each layer of operations, rather than the input data of the entire neural network. Similarly, output neuron data may refer to the output data at each layer of operations, rather than the output data of the entire neural network.

The input neuron data 102 may be processed based on a pooling kernel 106 to generate output neuron data 110. In some examples, the input neuron data 102 may be formatted as a two-dimensional data structure, e.g., a matrix, an image, or a feature map. The pooling kernel 106 may also refer to a two-dimensional data range, e.g., a two-dimensional window, based on which a specific portion of the input neuron data 102 may be selected.

In a non-limiting example, the input neuron data 102 may be formatted as an m×m image that includes m² pixels. Each of the pixels may include a value (e.g., brightness value, RGB value, etc.). The pooling kernel 106 may refer to an n×n window. Based on the pooling kernel 106, a portion of the input neuron data 102 within the n×n window may be selected.

In a maxpooling operation, a maximum value in the selected portion of the input neuron data 102 may be determined to a pooling result. The pooling kernel 106 may then be adjusted to a next position. For example, the pooling kernel 106 may be moved in one dimension, e.g., horizontally or vertically in an image, by one or more pixels. Another portion of the input neuron data 102 may be selected and another maximum value in the selected portion of the input neuron data 102 may be determined to be another pooling result. In other words, each time the pooling kernel 106 may be moved or adjusted, a pooling result may be generated.

Additionally, in the maxpooling operation, an index of the maximum value in the selected portion of the input neuron data 102 may be stored. For example, when the pooling kernel 106 refers to a 3×3 window, nine values within the window may be selected. If the nice values are indexed from left to right and from top to bottom, each of the values may be indexed by a number from 1 to 9. When the fourth value of these nine values is selected as the maximum value, the index (i.e., 4) may be stored. Each pooling result may be associated with an index. Thus, the indices may be output as an index vector 108.

In an average pooling operation, an average of the values in the selected portion of the input neuron data 102 may be calculated as a pooling result. Similarly, the pooling kernel 106 may be moved or adjusted to a next position. Another portion of the input neuron data 102 may be selected and another average may be calculated as a pooling result. The pooling results generated in the process may be output as the output neuron data 110. The output neuron data 110 may be transmitted to the (n+1)^{th} layer as input neuron data 114.

With respect to a backpropagation process at the n^{th} layer, input data gradients 116 may be transmitted from the (n+1)^{th} layer as output data gradients 112.

In a maxpooling operation of the backpropagation process, the index vector 108 may be multiplied with the output data gradients 112 to generate the input data gradients 104. In an average pooling operation of the backpropagation process, the output data gradients 112 may be multiplied by a reciprocal of a size of the pooling kernel 106. The size of the pooling kernel 106 may refer to a count of values that may be selected by the pooling kernel 106. For example, if the pooling kernel 106 is a 3×3 window, the output data gradients 112 may be multiplied by 1/9 to generate the input data gradients 104.

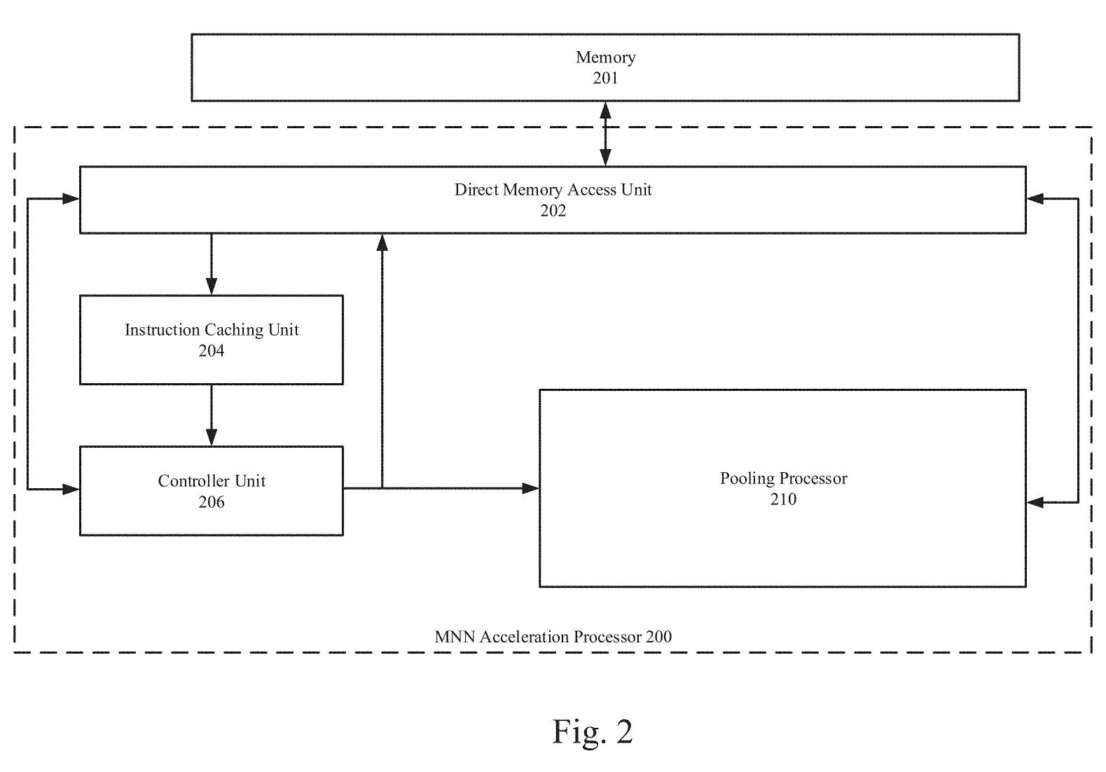

FIG. 2 is a block diagram illustrating an example MNN acceleration processor 200 by which pooling operations may be implemented in a neural network. As shown in FIG. 2, the example MNN acceleration processor 200 may include an instruction caching unit 204, a controller unit 206, a direct memory access unit 202, and a pooling processor 210. Any of the above-mentioned components or devices may be implemented by a hardware circuit (e.g., application specific integrated circuit (ASIC), Coarse-grained reconfigurable architectures (CGRAs), field-programmable gate arrays (FPGAs), analog circuits, memristor, etc.).

In some examples, the instruction caching unit 204 may be configured to receive or read instructions from the direct memory access unit 202 and cache the received instructions. The controller unit 206 may be configured to read instructions from the instruction caching unit 204 and decode one of the instructions into micro-instructions for controlling operations of other modules. The direct memory access unit 202 may be configured to access an external address range (e.g., in an external storage device such as a memory 201) and directly read or write data into caching units in the pooling processor 210.

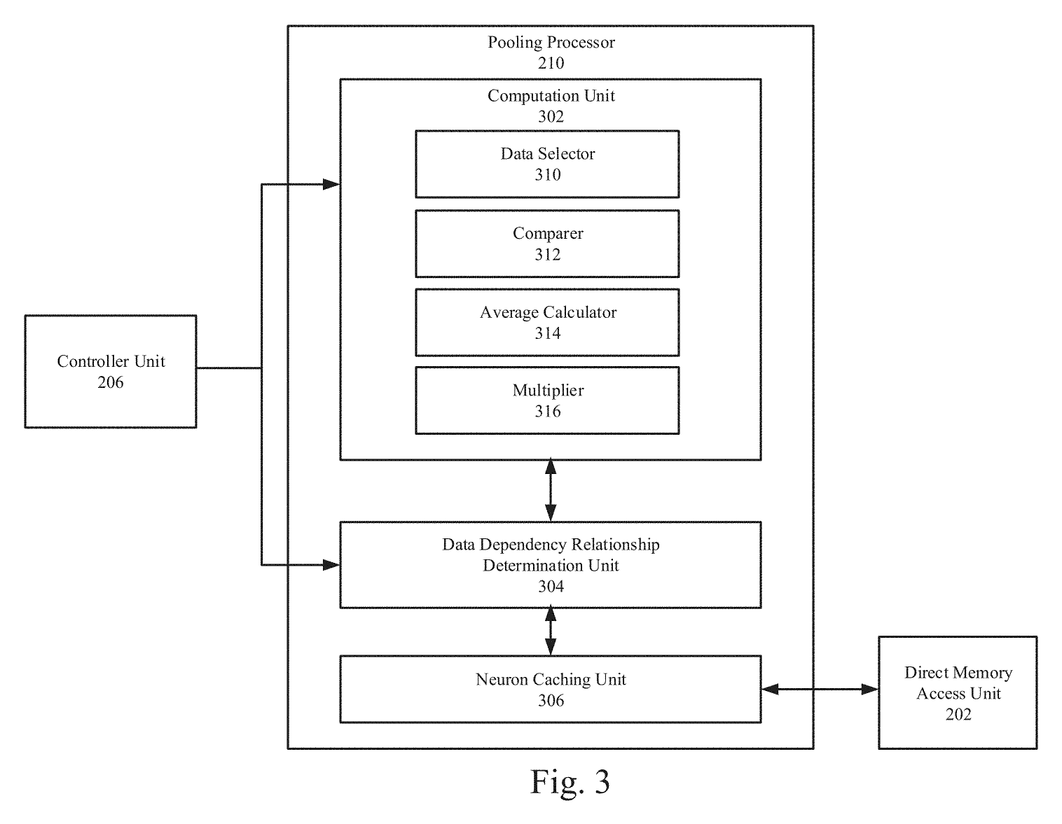

Upon receiving instructions, the pooling processor 210 may be configured to perform pooling operations that may be described in greater detail in accordance with FIG. 3.

FIG. 3 is a block diagram illustrating an example pooling processor 210 by which pooling operations may be implemented in a neural network. As depicted, the example pooling processor 210 may include a computation unit 302, a data dependency relationship determination unit 304, and a neuron caching unit 306. Hereinafter, a caching unit (e.g., the neuron caching unit 306) may refer to an on-chip caching unit integrated in the MNN acceleration processor 200, rather than other storage devices in memory 201 or other external devices. In some examples, the on-chip caching unit may be implemented as an on-chip buffer, an on-chip Static Random Access Memory (SRAM), or other types of on-chip storage devices that may provide higher access speed than the external memory.

The neuron caching unit 306 may be configured to cache or temporarily store data received from or to be transmitted to the direct memory access unit 202. The computation unit 302 may be configured to perform various computation functions. The data dependency relationship determination unit 304 may interface with the computation unit 302 and the neuron caching unit 306 and may be configured to prevent conflicts in reading and writing the data stored in the neuron caching unit 306.

For example, the data dependency relationship determination unit 304 may be configured to determine whether there is a dependency relationship (i.e., a conflict) in terms of data between a micro-instruction which has not been executed and a micro-instruction being executed. If not, the micro-instruction may be allowed to be executed immediately; otherwise, the micro-instruction may not be allowed to be executed until all micro-instructions on which it depends have been executed completely. For example, all micro-instructions sent to the data dependency relationship determination unit 304 may be stored in an instruction queue within the data dependency relationship determination unit 304. In the instruction queue, if the target range of reading data by a reading instruction conflicts or overlaps with the target range of writing data by a writing instruction of higher priority in the queue, then a dependency relationship may be identified, and such reading instruction cannot be executed until the writing instruction is executed.

With respect to an average pooling operation in a forward propagation computing process, the controller unit 206 may receive instructions for the pooling operation. The pooling processor 210 may receive the input neuron data 102. The pooling processor 210 may be further configured to store the input neuron data 102 and the pooling kernel in the neuron caching unit 306.

In more detail, according to the data range identified by the pooling kernel, a data selector in the computation unit 302 may be configured to select a portion of the input neuron data 102. For example, the input neuron data 102 may be formatted as a two-dimensional data structure such as

$$\begin{matrix}{a}_{11} & {a}_{12} & … & {a}_{1 i} & … & {a}_{1 n} \\ {a}_{21} & {a}_{22} & … & {a}_{2 i} & … & {a}_{2 n} \\ ⋮ & ⋮ & ⋮ & ⋮ & ⋱ & ⋮ \\ {a}_{j 1} & {a}_{j 2} & … & {a}_{j i} & … & {a}_{j n} \\ ⋮ & ⋮ & ⋮ & ⋮ & ⋮ & ⋮ \\ {a}_{m 1} & {a}_{m 2} & … & {a}_{m i} & … & {a}_{m n} .\end{matrix}$$

When the pooling kernel 106 includes a 3×3 data range, the data selector 310 may be configured to select a 3×3 portion from the input neuron data 102, e.g.,

$$\begin{matrix}{a}_{11} & {a}_{12} & {a}_{13} \\ {a}_{21} & {a}_{22} & {a}_{23} \\ {a}_{31} & {a}_{32} & {a}_{33} .\end{matrix}$$

The selected portion of the input neuron data 102 may also be stored in neuron caching unit 306. An average calculator 314 may be configured to calculate an average for the selected portion, e.g., Σ_{i,j=1}³aᵢⱼ/9. In some examples, the average calculator 314 may further include an adder and a divider. The calculated average may be stored in the neuron caching unit 306 as a pooling result.

Further, the computation unit 302 may be configured to adjust or move the pooling kernel 106. For example, the pooling kernel 106 may be adjusted to move horizontally by 1 value (1 pixel in the context of an image) to select another portion of the input neuron data 102, e.g.,

$$\begin{matrix}{a}_{12} & {a}_{13} & {a}_{14} \\ {a}_{22} & {a}_{23} & {a}_{24} \\ {a}_{32} & {a}_{33} & {a}_{34} .\end{matrix}$$

Another average may be calculated similarly for this selected portion and stored as another pooling result. When the pooling kernel 106 is adjusted to have traveled to the end of the input neuron data 102, the generated pooling results may be combined into the output neuron data 110.

With respect to a maxpooling operation in a forward propagation computing process, the data selector 310 may be similarly configured to select a portion of the input neuron data 102. A comparer 312 may be configured to select a maximum value from the selected portion of the input neuron data 102. Assuming a₂₁ is greater than other values in the selected portion, the comparer 312 may select a₂₁ and generate a₂₁ as a pooling result.

Further, an index associated with the selected maximum value may also be stored. In some examples, a₂₁ may be indexed as the fourth value in the selected portion of input neuron data 102. Accordingly, the index 4 may be stored in neuron caching unit 306 together with the maximum value a₂₁.

During the adjustment of the pooling kernel 106, one or more maximum values may be generated as the output neuron data 110 and one or more indices respectively associated with the maximum values may also be generated as an index vector 108.

With respect to an average pooling operation in a backpropagation computing process, a multiplier 316 may be configured to multiply the output data gradients 112 by a reciprocal of a size of the pooling kernel 106. The size of the pooling kernel 106 may refer to a count of values that may be selected by the pooling kernel 106. For example, if the pooling kernel 106 is a 3×3 window, the output data gradients 112 may be multiplied by 1/9 to generate the input data gradients 104.

With respect to a maxpooling operation in a backpropagation computing process, the multiplier 316 may be configured to multiply the output data gradients 112 by the index vector 108 to generate the input data gradients 104. The multiplication here may refer to a vector multiplication operation.

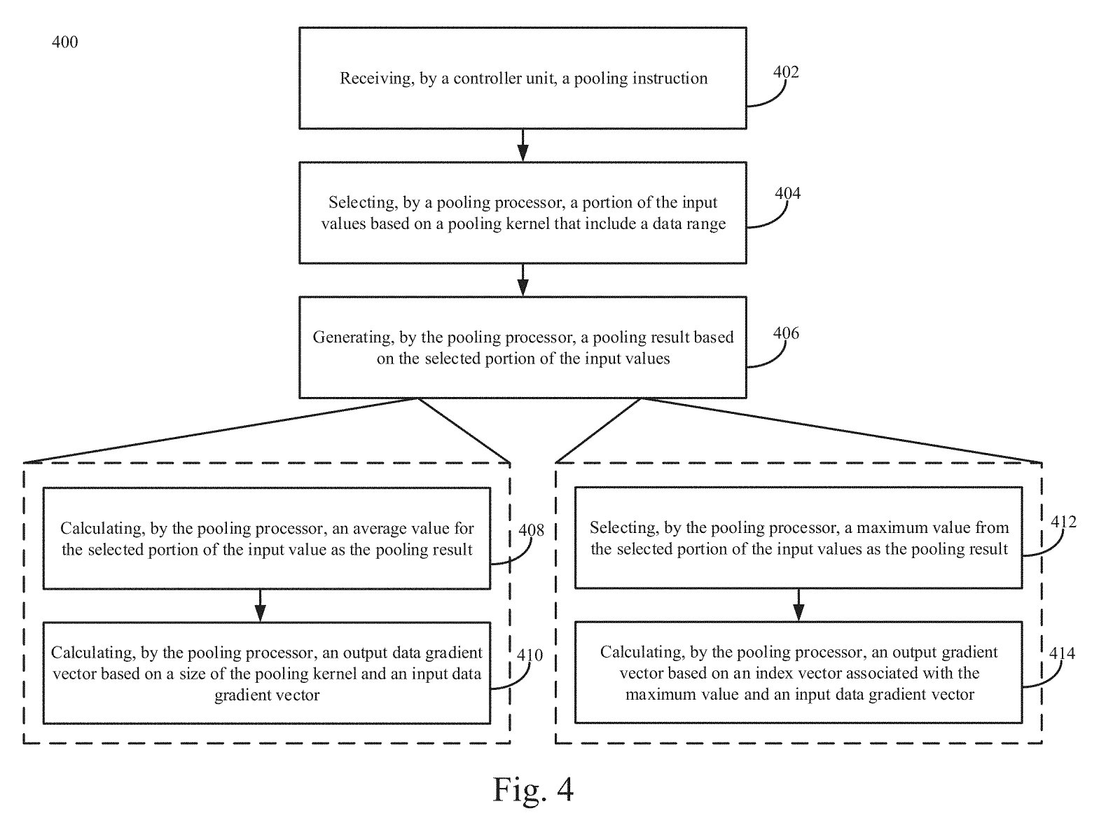

FIG. 4 is a flow diagram of aspects of an example method 400 for pooling operations in a neural network. The method 400 may be performed by one or more components of the apparatus of FIGS. 2 and 3.

At block 402, the example method 400 may include receiving, by a controller unit, a pooling instruction. For example, the controller unit 206 may be configured to read instructions from the instruction caching unit 204 and decode one of the instructions into micro-instructions for controlling operations of other modules.

At block 404, the example method 400 may include selecting, by a pooling processor, a portion of the input values based on a pooling kernel that include a data range. For example, the pooling processor 210 may be configured to receive the input neuron data 102 and the pooling kernel 106 from the memory 201. The input neuron data 102 and the pooling kernel 106 may be stored in the neuron caching unit 306. The pooling processor 210 or the data selector 310 included therein may be configured to select a portion of the input neuron data 102. For example, the input neuron data 102 may be formatted as a two-dimensional data structure such as

$$\begin{matrix}{a}_{11} & {a}_{12} & … & {a}_{1 i} & … & {a}_{1 n} \\ {a}_{21} & {a}_{22} & … & {a}_{2 i} & … & {a}_{2 n} \\ ⋮ & ⋮ & ⋮ & ⋮ & ⋱ & ⋮ \\ {a}_{j 1} & {a}_{j 2} & … & {a}_{j i} & … & {a}_{j n} \\ ⋮ & ⋮ & ⋮ & ⋮ & ⋮ & ⋮ \\ {a}_{m 1} & {a}_{m 2} & … & {a}_{m i} & … & {a}_{m n} .\end{matrix}$$

When the pooling kernel 106 includes a 3×3 data range, the data selector 310 may be configured to select a 3×3 portion from the input neuron data 102, e.g.,

$$\begin{matrix}{a}_{11} & {a}_{12} & {a}_{13} \\ {a}_{21} & {a}_{22} & {a}_{23} \\ {a}_{31} & {a}_{32} & {a}_{33} .\end{matrix}$$

The selected portion of the input neuron data 102 may also be stored in neuron caching unit 306.

At block 406, the example method 400 may include generating, by the pooling processor, a pooling result based on the selected portion of the input values. For example, the pooling processor 210 may be configured to generate a pooling result based on the selected portion of the input neuron data 102. Block 406 may further include blocks 408 and 410 that describe an average pooling process. Alternatively, block 406 may include blocks 412 and 414 that describe a maxpooling process.

At block 408, the example method 400 may include calculating, by the pooling processor, an average value for the selected portion of the input value as the pooling result. For example, the pooling processor 210 or the average calculator 314 included therein may be configured to calculate an average for the selected portion, e.g., Σ_{i,j=1}³aᵢⱼ/9. In some examples, the average calculator 314 may further include an adder and a divider. The calculated average may be stored in the neuron caching unit 306 as a pooling result.

At block 410, the example method 400 may include calculating, by the pooling processor, an output data gradient vector based on a size of the pooling kernel and an input data gradient vector. For example, a multiplier 316 of the pooling processor 210 may be configured to multiply the output data gradients 112 by a reciprocal of a size of the pooling kernel 106. The size of the pooling kernel 106 may refer to a count of values that may be selected by the pooling kernel 106. For example, if the pooling kernel 106 is a 3×3 window, the output data gradients 112 may be multiplied by 1/9 to generate the input data gradients 104.

At block 412, the example method 400 may include selecting, by the pooling processor, a maximum value from the selected portion of the input values as the pooling result. For example, the comparer 312 of the pooling processor 210 may be configured to select a maximum value from the selected portion of the input neuron data 102. Assuming a₂₁ is greater than other values in the selected portion, the comparer 312 may select a₂₁ and generate a₂₁ as a pooling result.

Further, an index associated with the selected maximum value may also be stored. In some examples, a₂₁ may be indexed as the fourth value in the selected portion of input neuron data 102. Accordingly, the index 4 may be stored in neuron caching unit 306 together with the maximum value a₂₁.

At block 414, the example method 400 may include calculating, by the pooling processor, an output gradient vector based on an index vector associated with the maximum value and an input data gradient vector. For example, the multiplier 316 may be configured to multiply the output data gradients 112 by the index vector 108 to generate the input data gradients 104. The multiplication here may refer to a vector multiplication operation.

The process or method described in the above accompanying figures can be performed by process logic including hardware (for example, circuit, specific logic etc.), firmware, software (for example, a software being externalized in non-transitory computer-readable medium), or the combination of the above two. Although the process or method is described above in a certain order, it should be understood that some operations described may also be performed in different orders. In addition, some operations may be executed concurrently rather than in order.

In the above description, each embodiment of the present disclosure is illustrated with reference to certain illustrative embodiments. Apparently, various modifications may be made to each embodiment without going beyond the wider spirit and scope of the present disclosure presented by the affiliated claims. Correspondingly, the description and accompanying figures should be understood as illustration only rather than limitation. It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

We claim:

1. An apparatus of pooling operation in a neural network, comprising:
a controller unit configured to receive a pooling instruction;
a pooling processor configured to:
receive multiple input values,
select a portion of the input values based on a pooling kernel that include a data range in response to the pooling instruction, and
generate a pooling result based on the selected portion of the input values.

2. The apparatus of claim 1, wherein the pooling processor is configured to calculate an average value for the selected portion of the input values as the pooling result.

3. The apparatus of claim 1, wherein the pooling processor is configured to select a maximum value from the selected portion of the input values as the pooling result.

4. The apparatus of claim 1, wherein the input values are indexed as a two-dimensional data structure.

5. The apparatus of claim 1, wherein the data range of the pooling kernel is a two-dimensional data range.

6. The apparatus of claim 1, wherein the pooling processor is further configured to adjust the data range in the pooling kernel.

7. The apparatus of claim 1, wherein the pooling processor is further configured to calculate an output data gradient vector based on a size of the pooling kernel and an input data gradient vector.

8. The apparatus of claim 3, wherein the pooling processor is further configured to calculate an output gradient vector based on an index vector associated with the maximum value and an input data gradient vector.

9. A method for pooling operation in a neural network, comprising:
receiving, by a controller unit, a pooling instruction;
receiving, by a pooling processor, multiple input values;
selecting, by the pooling processor, a portion of the input values based on a pooling kernel that include a data range in response to the pooling instruction; and
generating, by the pooling processor, a pooling result based on the selected portion of the input values.

10. The method of claim 9, further comprising calculating, by the pooling processor, an average value for the selected portion of the input values as the pooling result.

11. The method of claim 9, further comprising selecting, by the pooling processor, a maximum value from the selected portion of the input values as the pooling result.

12. The method of claim 9, wherein the input values are indexed as a two-dimensional data structure.

13. The method of claim 9, wherein the data range of the pooling kernel is a two-dimensional data range.

14. The method of claim 9, further comprising adjusting, by the pooling processor, the data range in the pooling kernel.

15. The method of claim 9, further comprising calculating, by the pooling processor, an output data gradient vector based on a size of the pooling kernel and an input data gradient vector.

16. The method of claim 11, further comprising calculating, by the pooling processor, an output gradient vector based on an index vector associated with the maximum value and an input data gradient vector.
